(19) United States
(12) Patent Application Publication
(10) Pub. No.: US 2010/0167646 A1
(43) Pub. Date: Jul. 1, 2010

(54) METHOD AND APPARATUS FOR DEVICE PAIRING

(75) Inventors: RACHID ALAMEH, Crystal Lake, IL (US); Michael Russell, Lake Zurich, IL (US)

Correspondence Address: Guntin Meles & Gust, PLC (Mot), 318 Indian Trace #750, Weston, FL, 33326, US

(73) Assignee: MOTOROLA, INC., SCHAUMBURG, IL (US)

(21) Appl. No.: 12/349,294

(22) Filed: Jan. 6, 2009

Related U.S. Application Data
(60) Provisional application No. 61/141,451, filed on Dec. 30, 2008.

(51) Int. Cl. H04B 7/00

(52) U.S. Cl. 455/41.2

(57) ABSTRACT

A device (102 or 104 or 301) and method (400) of pairing electronic devices can include detecting (402) a physical orientation of at least two electronic devices, detecting (404) acceleration data when the at least two electronic devices are initially shaken together in immediate proximity, generating (406) a code shared by the at least two electronic devices when initially shaken together, and pairing (408) the at least two electronic devices by using an accelerometer (311) when the at least two electronic devices are subsequently shaken together and a match is found with the acceleration data and the shared code among the at least two electronic devices.

### CROSS REFERENCE TO RELATED APPLICATIONS

The present application claims the benefit of priority to U.S. Provisional Application No. 61/141,451 filed on Dec. 30, 2008, which is hereby incorporated herein by reference.

### FIELD

This subject matter herein relates generally to device pairing and more particularly to techniques for pairing using accelerometers.

### BACKGROUND

Techniques of pairing devices such as Bluetooth short-range radio enabled devices typically require users to select a device from a list of devices and further enter a personal identification number or PIN supplied with the device in order to pair the devices up. Many users view the requirement of sorting through a list and further entering a PIN to pair devices in their close proximity as chore, particularly when the devices are in close proximity. Many phones and headsets apparently have a “0000” default PIN code which creates a significant security weakness since many users do not bother to change the default PIN or purposely leave the default PIN.

Although several papers discuss the ability to pair devices by sharing accelerometer data after shaking, none necessarily provide the necessary detail to enable to pair Bluetooth enabled or other enabled devices in a secure and convenient manner suitable for all the functions and features in a smartphone for example.

### SUMMARY

Embodiments in accordance with the present invention can provide the pairing or partnering of devices by monitoring the movement or shaking of devices using an accelerometer. The movement can be used for pairing or file transfer or device programming. The accelerometer in each device should generate the same data since the devices such as portable phones are on top of each other or in immediate proximity of each other and acting as one body. Phone tilt data with respect to gravity can also be used to offset or translate non-aligned devices or to differentiate among functions.

In a first embodiment of the present invention, a method of pairing electronic devices can include detecting a physical orientation of at least two electronic devices, detecting acceleration data when the at least two electronic devices are initially shaken together in immediate proximity, generating a code shared by the at least two electronic devices when initially shaken together, and pairing the at least two electronic devices by using an accelerometer when the at least two electronic devices are subsequently shaken together and a match is found with the acceleration data and the shared code among the at least two electronic devices.

In a second embodiment of the present invention, a mobile device having a controller can be operable to detect a physical orientation relative to at least a second mobile device, generate acceleration data at the mobile device when moving the mobile device, detect acceleration data of the at least second mobile when the mobile device and the at least second mobile device are initially shaken together in immediate proximity, generate a shared code by the mobile device and the at least second mobile device, and pair the mobile device with at least second mobile device by using an accelerometer when the at least two electronic devices are subsequently shaken together and a match is found with the acceleration data and the shared code between the mobile device and the at least second mobile device.

In a third embodiment of the present invention, a device can include a method in a mobile device including detecting a physical immediate proximity to a second device, detecting acceleration data when the mobile device and at least the second device are initially shaken together in immediate proximity, generate a code shared by mobile device and at least the second device when initially shaken together, and pairing the mobile device with at least the second device by using an accelerometer when the mobile device and at least the second device are subsequently shaken together and a match is found with the acceleration data and the shared code.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program” or “software application” are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a pair of devices oriented relative to each other in accordance with embodiments of the present invention.

FIG. 2 is a mobile phone and headset paired in a manner in accordance with an embodiment of the present invention.

FIG. 3 is a block diagram of an electronic device in accordance with an embodiment of the present invention.

FIG. 4 is flow chart illustrating a method of pairing electronic devices in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of ways using a variety of technologies that enable the monitoring of movement of two or more devices for pairing, programming, transferring or other functions shared between the devices.

More particularly in one embodiment, a pair of devices 102 and 104 in a system 100 is shown in 5 different configurations (a-e). In “a”, the devices such as two cellular phones are placed on top of each other and oriented in the same direction. In “b”, the devices are placed together and aligned. In “c”, the devices 102 and 104 are orthogonal to each other. In “d”, the devices are 180 degrees relative to each other. In “e”, the devices 102 and 1 04 are rotated to a certain degree relative to each other. In each instance, the two devices or phones can be placed together to essentially form one body and then they are shaken together. The movement can be vigorous or very slight, but in either event the movement is monitored or tracked using an accelerometer. An accelerometer in each device can generate the same data since the phones are on top of each other acting as one body and phone tilt data with respect to gravity is available to offset/translate non-aligned devices if necessary. If the accelerometer data matches for each device, then the devices can then be enabled for pairing, file transfer, device programming or any number of other functions if desired.

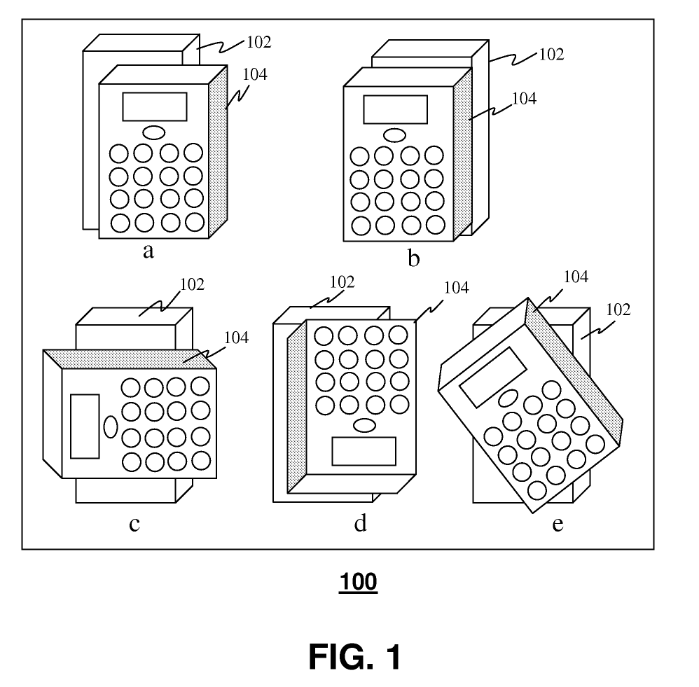

The scheme depicted in “e” of FIG. 1 can also entail two phones that are in contact but rotating with respect to each other. In one embodiment, clock wise rotation could lead to pairing, counter clock wise could lead to file sharing, or a certain degree of rotation can lead to yet other functions. By keeping phones in contact during rotation, a common mode accelerometer signal can be created. For example, if phones are vertical, one axis behaves the same between phones and the other two change due to rotation. If phones are carried with a tilt, a constant common mode vector between the phones is achieved indicating phones in contact and rotating. Different functions can be enabled based on the orientation or rotation relative to each of the devices.

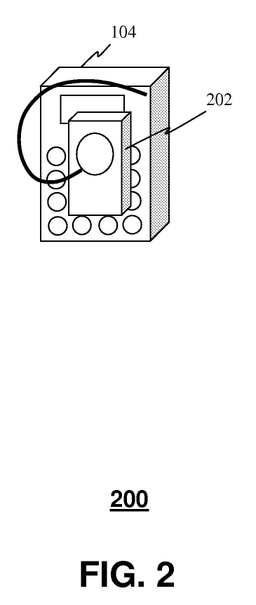

Note that the devices are not limited to cellular phones, but can be used with most portable electronic devices that can have some form of wireless communication. For example as shown in FIG. 2, the system 200 can include the device 104 such as a cellular phone and a wireless headset 202 which can be paired using any number of wireless communication schemes such as Bluetooth, infrared, RFID, capacitive touch sensor, proximity sensor, acoustic sensor (speaker/Microphone communicating final value), IR sensor, or WIFI among others

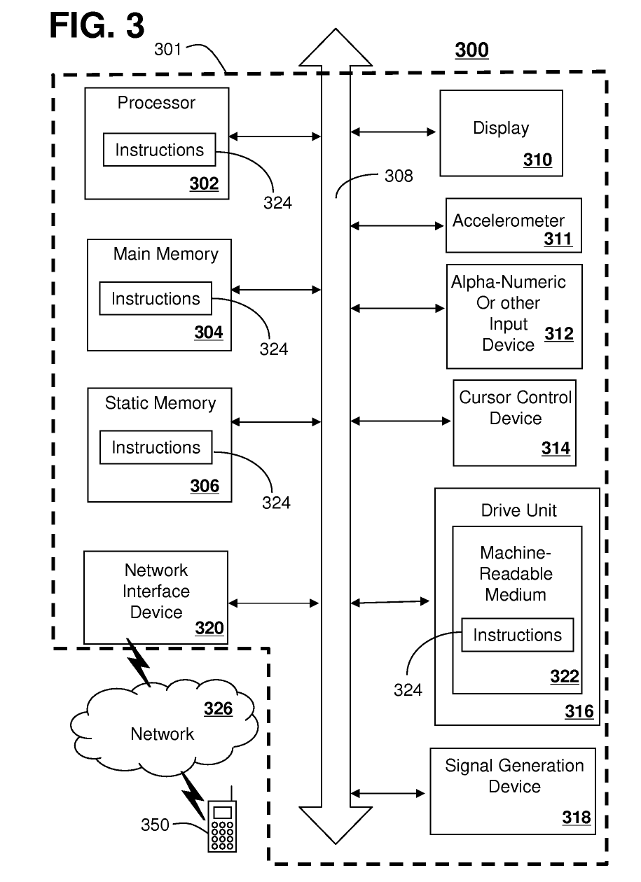

In another embodiment of the present invention as illustrated in the diagrammatic representation of FIG. 3, an electronic product 301 such as a machine having a display 310 can include a processor or controller 302 coupled to the display. The device 301 can be a hand-held device selected among a cellular phone, a personal digital assistant, a smart phone, an MP3 Player, a music player, a remote controller, a wrist-worn computer, and a watch for example. Generally, in various embodiments it can be thought of as a machine in the form of a computer system 300 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 301 and a sending device 350 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 300 can include a controller or processor 302 (e.g., a central processing unit (CPU), a graphics processing unit (GPU, or both), a main memory 304 and a static memory 306, which communicate with each other via a bus 308. The computer system 300 may further include a presentation device such the flexible display 310. The computer system 300 may include an accelerometer 311, an input device 312 (e.g., a keyboard, microphone, etc.), a cursor control device 314 (e.g., a mouse), a disk drive unit 316, a signal generation device 318 (e.g., a speaker or remote control that can also serve as a presentation device) and a network interface device 320. Of course, in the embodiments disclosed, many of these items are optional.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor or controller 302 during execution thereof by the computer system 300. The main memory 304 and the processor or controller 302 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The accelerometers can be used in any number of configurations or varieties. The accelerometer 311 can be a three axis accelerometer(s). Each axis can be scaled to more accurately compare between different vendor phones with different accelerometers. If desirable, vibration direction can also be eliminated (just acceleration amplitude is kept). The data in each of the axis can be communicated in raw form (such as serial samples over the motion period which can be 2 seconds) or translated into an equivalent number for simple conveying between devices. Each axis data is then transmitted and compared with the accelerometer data in the receiving phone. When there is a match (or data close enough to be considered a match), pairing, file transfer, or other functions can be enabled or activated. The decision for a match could be conducted on all three axis, on two axis, or just one axis. Comparing individual accelerometer axis allows for phones with differing accelerometers capabilities to be paired (for example, a phone with a three axis accelerometer can be compared with a phone having a two axis accelerometer).

Following the shaking/motion of the combined devices (such as phones), each phone communicates its accelerometer data to the other mated phone via RFID, capacitive touch sensor, proximity sensor, acoustic sensor (speaker/Mic communicating final value), IR sensor, Bluetooth or WIFI.

Bluetooth connections often involve three processes, namely, the Inquiry, Paging, and Pairing processes. The Inquiry process is used to discover unknown devices. The Inquiry process can only look for certain class of devices, such as a headset or phone, and return those from its search or include every device that has responded in the vicinity. The Paging process is used to establish any Bluetooth connection either from a device found during the inquiry process or from a previously known device. The pairing process is used to form a trusted link and pair the devices after the paging process provides the initial connection. This Pairing process uses a procedure called Bonding whereby devices authenticate each other based on an authentication key and an initialization key, which both devices contribute to via a PIN or passkey. All three steps can be used for connecting two new devices and from then on these two devices would only need to use the Paging process. They have the information from the Pairing process for an “authenticated” link and would not need to do this again.

The shaking/gesture mechanism can be used to trigger the steps for the Bluetooth connection process, such as Inquiry and Paging, without needing to use the menu driven options. Since both devices only want to connect to each other and not other devices in the vicinity, the Bluetooth Class of Device (COD) could be changed from the usual Handsfree, File Transfer, or Streaming Stereo functions to something unique between these two devices so they would only discover and connect to each other and not other devices within the 10-100 meter range defined for Bluetooth. This COD could be set using accelerometer data and would be unique for each connection or it could just be a static ID that a manufacturer uses for a “shaken/gesture” device and then changes the COD back to the original device type.

Once the initial connection has been established, then the accelerometer data could be used for the pairing process to establish the initialization key between the two devices since their metrics from the accelerometer should be the same or nearly the same each accelerometer can generate the same PIN code, initialization key, or link key. This prevents any eavesdropping on the link because no other device would be able to match the accelerometer state of the two Bluetooth devices. This technique of initial code creation is not necessarily limited to Bluetooth device, but can be applied to other communication schemes. Additionally, this shake/gesture feature could be used with a phone that has an accelerometer and another device that does not. So the shaking mechanism could be used on the phone to initiate the discovery and connection mechanisms and when the headset is turned on it is designed to be automatically discoverable. In this instance the special COD would not be found because both devices do not have an accelerometer and the normal pairing process can occur for the headset, where the phone can cycle through and input a list of preset pins, such as 0000. In this case the accelerometer wouldn't set the pin, but only one button is pressed to turn the headset on, which needs to be done anyway.

In order to account for the case when two devices have already been paired the phones can alternate between trying to discover new devices with this special COD and Paging devices that have previously been Paired.

The different use cases of transferring files or profile programming can be based upon the context of the two devices and the two device types. So when a phone pairs with a headset, it would use the available audio profiles. If a phone pairs with another phone and it has a file, contact, song or picture highlighted, then it would transfer that object when shaken. If the device or phone was operating on a calendar or some sort of configuration setting, then it would configure the mating device or phone.

Bluetooth has the ability to discover a device and be discoverable or page a device and listen for pages concurrently. For example, a Bluetooth device can send inquiries and also listen to inquiries since the medium is time division-duplexed. So Bluetooth devices have a mechanism to scan and be scanned at the same time. Most wireless technologies have some sort of Master/Slave or Initiator/Target paradigm, such as WiFi or NFC, and don't necessarily have mechanisms that handle discoverability the same way as Bluetooth. NFC for instance has to have the Initiator device turn on its near-field to power and query the target device. So once shaken, which device should be the target and which should be the Initiator? The shaking/gesture mechanism can trigger the start of the wireless transport and can solve a transmitter problem by having each device run a random back off timer before it starts trying to take the medium to be the initiator and listen during the timer interval as the target.

Once the accelerometer data is received by each phone, it is compared with locally generated accelerometer data. For high security pairing, all three axis can be compared for match. For low security setting, only one of the axis can be use to match. To help eliminate parts and manufacturers tolerance between different types of accelerometers, the raw data can be scaled before a one to one comparison. Because both phones are on top of each other, the accelerometer data is expected to be similar between the two phones. This scheme provides the benefit over known art in that the user could perform this task without requiring access to a keypad, fumbling through a menu to search for nearby devices, or even looking at the phones.

If phones embed accelerometers in opposite locations (for example, one phone has it near a speaker and the other phone has it near the microphone on an opposing end of the phone), then rotation (as a motion) should be avoided as accelerometers output could be different. Other motions can be used to pair. In such an instance a user can simply place the phones on top of each other and just tap once on the phones. Typically, if one of the axis match, then pairing is enabled. If X1 (x axis of accelerometer 1) and X2 (of accelerometer 2) do not match, then x1 is compared with y2 in case layouts of accelerometers are rotated between the phones.

This scheme works with any device or phone sizes, shapes, and housing form factors. Generally, all the user would do in accordance with the embodiments would be to grab the two phones together as one body and make a slight motion. This is simple and highly reliable since the phones or devices are not necessarily recognizing/capturing a certain motion but rather confirming that two phones acting as one generate similar data as expected (within a tolerance window). Once mated, the user can then share files or perform other functions. A user can locate a file or files to transfer to the other device either by pressing a key or by conducting the same task again as described above (grab phones together and make any motion to transfer file). The action of physically grabbing two phones as one gives the visual feedback of the devices being paired and sharing files. This is another level of “visual” security and practicality achieved by this scheme.

The embodiments herein enable master-slave phone access programming on the fly by use of the scheme described above between a master phone and a slave phone (parent and child phones). The Master phone can have various profiles stored (for each family member for example). The Master can program a family member phone on the fly by conducting the scheme described above (shake and pair/program). Such programming could entail dial capability, access level, daily talk time limit, application access, download capability, long distance calling, or any other number of functions of limits.

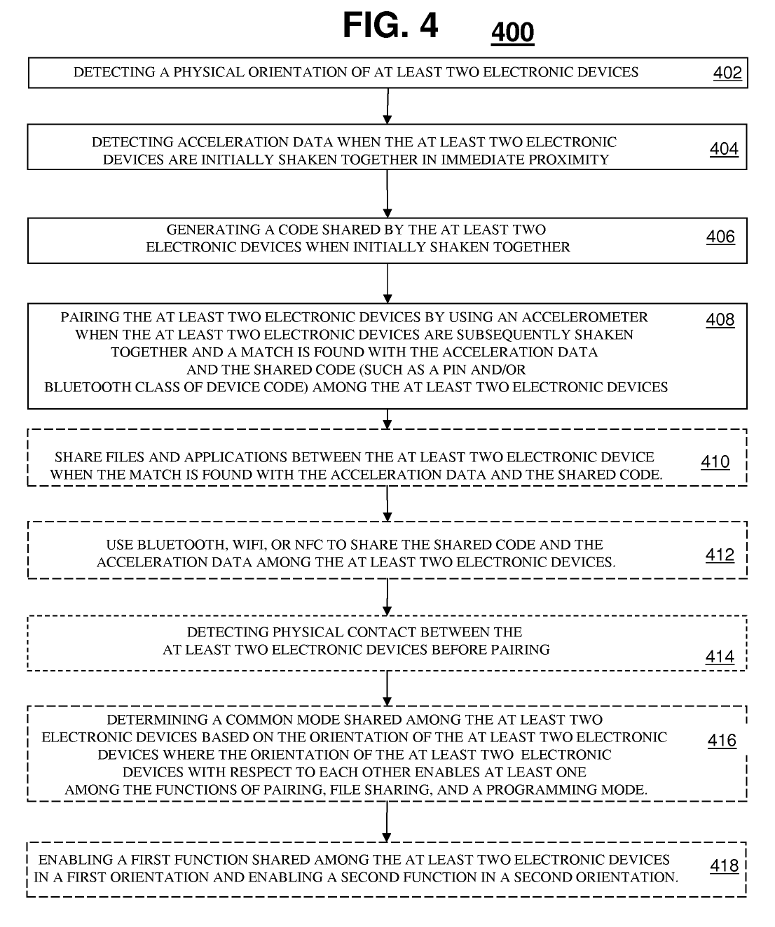

Referring to FIG. 4, a flow chart illustrating a method 400 can entail pairing electronic devices such as phones by detecting a physical orientation of at least two electronic devices at 402, detecting acceleration data when the at least two electronic devices are initially shaken together in immediate proximity at 404. The method 400 at 406 can then generate a code shared by the at least two electronic devices when initially shaken together and then at 408 the method can pair the at least two electronic devices by using an accelerometer when the at least two electronic devices are subsequently shaken together and a match is found with the acceleration data and the shared code among the at least two electronic devices. At 410, the method can share files and applications between the at least two electronic devices when the match is found with the acceleration data and the shared code. The shared code can be a personal identification code or PIN or a Bluetooth Class of Device (COD) code for example. Note that the method can use at 412 Bluetooth, WiFi, or near-field communication (NFC) to share the shared code and the acceleration data among the at least two electronic devices. The method at 414 can optionally detect physical contact between the at least two electronic devices before pairing. At 416, the method can determine a common mode shared among the at least two electronic devices based on the orientation of the at least two electronic devices with respect to each other. The orientation of the at least two electronic devices with respect to each other enables at least one among the functions of pairing, file sharing, and a programming mode. At 418, the method enables a first function shared among the at least two electronic devices in a first orientation and enables a second function in a second orientation based on the relative orientation of the at least two electronic devices with respect to each other.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of pairing electronic devices, comprising:
detecting a physical orientation of at least two electronic devices;
detecting acceleration data when the at least two electronic devices are initially shaken together in immediate proximity;
generate a code shared by the at least two electronic devices when initially shaken together; and
pairing the at least two electronic devices by using an accelerometer when the at least two electronic devices are subsequently shaken together and a match is found with the acceleration data and the shared code among the at least two electronic devices.

2. The method of claim 1, wherein the method shares files and applications between the at least two electronic device when the match is found with the acceleration data and the shared code.

3. The method of claim 1, wherein the shared code is a personal identification number.

4. The method of claim 1, wherein the shared code is a Bluetooth Class of Device code and a personal identification number.

5. The method of claim 1, wherein the method uses Bluetooth, WiFi, or NFC to share the shared code and the acceleration data among the at least two electronic devices.

6. The method of claim 1, wherein the method further requires the detection of physical contact between the at least two electronic devices before pairing.

7. The method of claim 1, wherein the orientation of the at least two electronic devices with respect to each other determines a common mode shared among the at least two electronic devices.

8. The method of claim 1, wherein the orientation of the at least two electronic devices with respect to each other enables at least one among the functions of pairing, file sharing, and a programming mode.

9. The method of claim 1, wherein the relative orientation of the at least two electronic devices with respect to each other enables a first function shared among the at least two electronic devices in a first orientation and enables a second function in a second orientation.

10. A mobile device, comprising a controller operable to:
detect a physical orientation relative to at least a second mobile device;
generate acceleration data at the mobile device when moving the mobile device;
detect acceleration data of the at least second mobile when the mobile device and the at least second mobile device are initially shaken together in immediate proximity;
generate a shared code by the mobile device and the at least second mobile device; and
pair the mobile device with at least second mobile device by using an accelerometer when the at least two electronic devices are subsequently shaken together and a match is found with the acceleration data and the shared code between the mobile device and the at least second mobile device.

11. The mobile device of claim 10, wherein the controller shares files and applications between the mobile device and the at least second mobile device when the match is found with the acceleration data and the shared code.

12. The mobile device of claim 10, wherein the shared code is a personal identification number.

13. The mobile device of claim 10, wherein the shared code is a Bluetooth Class of Device code and a personal identification number.

14. The mobile device of claim 10, wherein the controller uses Bluetooth, WiFi, or NFC to share the shared code and the acceleration data between the mobile device and the at least second mobile device.

15. The mobile device of claim 10, wherein the controller requires the detection of physical contact between the mobile device and the at least second mobile device.

16. The mobile device of claim 10, wherein the controller detects the orientation of the mobile device with respect to the at least second mobile device to enable at least one among the functions of pairing, file sharing, and a programming mode.

17. A method in a mobile device, comprising:
detecting a physical immediate proximity to a second device;
detecting acceleration data when the mobile device and at least the second device are initially shaken together in immediate proximity;
generate a code shared by mobile device and at least the second device when initially shaken together; and
pairing the mobile device with at least the second device by using an accelerometer when the mobile device and at least the second device are subsequently shaken together and a match is found with the acceleration data and the shared code.

18. The method of claim 17, wherein the method comprises detecting a physical orientation of the mobile device relative to at least the second device.

19. The method of claim 18, wherein the relative orientation to each other of the mobile device and at least the second device enables a first shared function in a first orientation and enables a second function in a second orientation.

20. The method of claim 17, wherein only the mobile device has an accelerometer that generates the acceleration data.
